(19) United States
(12) Patent Application Publication
(10) Pub. No.: US 2013/0033371 A1
(43) Pub. Date: Feb. 7, 2013

(54) METHOD FOR WARNING OF AN OBJECT IN THE VICINITY OF A VEHICLE AND DRIVING ASSISTANCE SYSTEM

(71) Applicants: Mike Schliemann, Schwieberdingen (DE); Florian Kloss, Zwickau (DE); Nico Latsch, Oppenweiler (DE)

(72) Inventors: Mike Schliemann, Schwieberdingen (DE); Florian Kloss, Zwickau (DE); Nico Latsch, Oppenweiler (DE)

(73) Assignee: Robert Bosch GMBH, Stuttgart (DE)

(21) Appl. No.: 13/511,571

(22) PCT Filed: Oct. 14, 2010
(86) PCT No.: PCT/EP2010/065389

§ 371 Date: Oct. 4, 2012

(30) Foreign Application Priority Data
Nov. 24, 2009 (DE) 10 2009 047 066.2

(51) Int. Cl. B60Q 1/00

(52) U.S. Cl. 340/435

(57) ABSTRACT

A method for warning of an object in the surroundings of a vehicle. The method includes the following steps of detecting a position of the object in a detection region in the surroundings of the vehicle, the detection region being a region in the surroundings of the vehicle and being adjacent to a driving track region of the vehicle, the driving track region being a region through which the vehicle will drive, in particular within a predetermined time span, determining a motion of the object on the basis of multiple detected positions of the object, and signaling when a determination is made that the object in the detection region is moving.

### FIELD OF THE INVENTION

The present invention relates to a method for warning of an object in the surroundings of a vehicle, to a computer program for executing a corresponding method, and to a driver assistance system in which the warning method is used.

### BACKGROUND INFORMATION

Methods for warning of an object in the surroundings of a vehicle, and driver assistance systems, are commonly known from the existing art.

German patent document DE 10 2006 002 232 A1, for example, discusses a method for monitoring a region not visible to a driver. In this method, when the vehicle is stationary, ultrasonic sensors ascertain a distance of an object from the vehicle within the non-visible region. The distance of the object from the vehicle is stored again as a reference state each time the vehicle is stationary, and is tracked over a specific time span. Upon a decrease, as compared with the stored reference state, in the distance when the vehicle is stationary, a signal is transmitted to the driver. A further signal is triggered when, in the context of a driver's initial movement request -- deducible from the accelerator pedal position and/or the state of the drivetrain and/or the state of the braking device -- the distance is less than the corresponding distance in the stored reference state. In accordance with the method, a signal is thus generated only if an intention exists on the part of the driver to set the vehicle in motion, and if an object's distance from the vehicle decreases.

A disadvantage with the method explained above is believed to be that only objects that are located within the monitored region when the vehicle is stationary are incorporated into the reference creation process. For example, objects that enter the region while driving, or objects moving parallel to the vehicle, are not sensed by the method described in the existing art.

### SUMMARY OF THE INVENTION

It is therefore an object of the exemplary embodiments and/or exemplary methods of the present invention to make available a method and an apparatus for warning of an object in the surroundings of a vehicle with which collision-relevant objects can be recognized even while driving. A further object of the exemplary embodiments and/or exemplary methods of the present invention is to make available a method and an apparatus that are capable of blanking out non-collision- relevant objects.

These objects may be achieved by the method according to the descriptions herein for warning of an object in the surroundings of a vehicle, and by a computer program for executing a corresponding method, and a driver assistance system, in accordance with the coordinated claims.

Further advantageous embodiments of the present invention are further described herein.

In accordance with a first aspect, a method for warning of an object in the surroundings of a vehicle is provided. The method encompasses the following steps:
detecting a position of the object in a detection region in the surroundings of the vehicle, the detection region being a region in the surroundings of the vehicle and being adjacent to a driving track region of the vehicle, the driving track region being a region through which the vehicle will drive, in particular within a predetermined time span;
determining a motion of the object on the basis of multiple detected positions of the object;
signaling when a determination is made that the object in the detection region is moving.

An idea of the above method consists in analyzing the surroundings of a vehicle with respect to the presence of an object that might represent a source of risk, and, if applicable, warning of that object. The analysis occurs independently of the absolute position of the vehicle, i.e. the vehicle can be in motion during the analysis.

For purposes of the present method, an “object” can be any moved or moving object, or also any stationary object, such as a traffic participant, a building, or another stationary or moving obstacle. Very small objects such as birds, stones, and other small items, however, are intended to remain unconsidered in the context of the above method. This can be accomplished by the fact that the detection accuracy is defined so that these items are not recognized, or alternatively, if such items are recognized, a check is carried out in which objects that are smaller than a specific size are not taken into consideration or are not included as objects for purposes of the exemplary embodiments and/or exemplary methods of the present invention.

By way of the method for warning of an object, a differentiation can be performed between potentially collision-relevant and non-collision-relevant objects. For this, the surroundings of the vehicle are divided into two regions, namely into a driving track region and a detection region delimited therefrom. The driving track region is the region that the vehicle will drive through, because of its driving motion and driving direction, within a specific time span. It is directly adjacent to the vehicle and has a defined length and width. When the vehicle is driving straight ahead, the driving track region thus has a square or rectangular shape, and when negotiating a curve it has the shape of a curve segment. The detection region is delimited in terms of length and width, and is adjacent to the driving track region. The detection region can entirely surround the driving track region, or can also be partially adjacent to the driving track region, for example to the right and/or left boundary of the driving track region in the driving direction.

To allow a determination of the relevance of an object in the detection region, the position of the object is identified over a specific time span or at multiple points in time. The motion of the object can be determined on the basis of the detected positions. The motion direction as well as the speed are ascertained in the context of the determination of the motion of the object. As a result, an estimate can be made as to whether or not the object in the detection region can develop into a collision-relevant object. After the estimate, on the one hand a selective reaction to a collision-relevant object can occur and, if applicable, a signal can be triggered. On the other hand, an object that is not a source of risk can be blanked out. Initially, a moving object in the detection region is assessed as collision-relevant.

According to a refinement, provision can be made that signaling is carried out only when a determination is made that the object in the detection region is moving in the direction of the driving track region.

Provision can further be made that signaling is carried out only when a determination is made that the object in the detection region is moving into the driving track region within a specific time span.

Signaling can furthermore be carried out only when a determination is made that the object is stationary and will enter from the detection region (3) into the driving track region within a specific time span.

The method can furthermore encompass the further steps of:
detecting a position of a further object within the driving track region,
signaling when a determination is made that the further object is located in the driving track region.

The driving track region and/or the detection region can furthermore be defined as a function of the vehicle speed.

Signaling can be carried out optically and/or acoustically.

According to a further aspect, a computer program is provided which contains a program code that, when it is executed on a data processing unit, executes a method according to the present invention.

According to a further aspect, the exemplary embodiments and/or exemplary methods of the present invention encompass a driver assistance system for warning of an object in the surroundings of a vehicle. The driver assistance system encompasses
at least one sensor for detecting a position of the object in a detection region, the detection region being a region in the surroundings of the vehicle and being adjacent to a driving track region, and the driving track region being a region that the vehicle will drive through, in particular within a specific time span;
a data processing unit for determining a motion of the object on the basis of multiple detected positions of the object;
a signal transducer for signaling when a determination is made that the object in the detection region is moving.

The at least one sensor can be a sensor that monitors a sensor region in front of, alongside, and/or behind the vehicle.

Exemplary embodiments are explained in further detail below with reference to the drawings.

### BRIEF DESCRIPTION OF THE DRAWINGS

FIG. 1 shows a vehicle having a driving track region and a detection region.

FIG. 2 shows a flow chart for a method for warning of an object in the surroundings of a vehicle.

### DETAILED DESCRIPTION

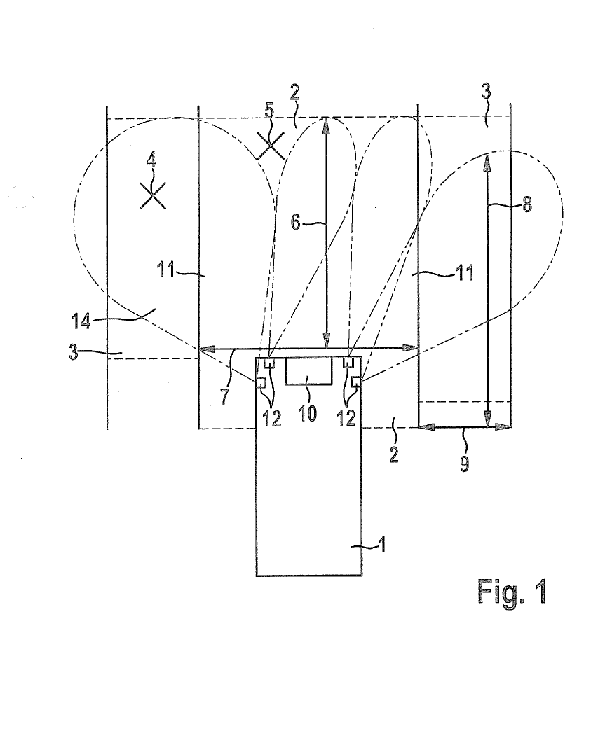

FIG. 1 is a schematic depiction of a vehicle 1 having a driver assistance system 10. Driver assistance system 10 encompasses at least one sensor 12 that can detect the position of an object 4 in a driving track region 2 and in a detection region 3, separate and delimited therefrom, in the surroundings of vehicle 1. Driving track region 2 is defined as the region that will be driven through by vehicle 1 in a specific time span such as, in the example, in two seconds. Driving track region 2 is thus defined by the speed and driving direction or steering wheel position. It is immediately adjacent to vehicle 1 and has a defined length 6 and width 7. When vehicle 1 is driving straight ahead, driving track region 2 thus has a square or rectangular shape, and when negotiating a curve it is has the shape of a curve segment. Driving track region 2 thus represents the immediate risk region around vehicle 1. Adjacent to driving track region 2 is detection region 3, which represents an expanded risk region and is to be monitored in a different manner than driving track region 2.

Driving track region 2 and detection region 3 are made available by driver assistance system 10 in the form of a coordinate system which ensures that data regarding the position of object 4 can be ascertained precisely. The dimensions of driving track region 2 as well as the dimensions of detection region 3 can be defined as a function of vehicle speed. Detection region 3 can entirely surround driving track region 2 or can also be partially adjacent to driving track region 2, for example to the right and/or left boundary of driving track region 2 in the driving direction. For example, when the speed of vehicle 1 is 100 km/h, driving track region 2 can have a length 6 of approximately 50 m and a width 7 of approx. 3 m. For a corresponding speed, detection region 3 alongside driving track region 2 can respectively have a length 8 of approx. 50 m and a width 9 of approx. 2 m.

Driver assistance system 10 of FIG. 1 has four sensors 12; driver assistance system 10 can, however, also encompass more or fewer sensors 12. Ultrasonic, lidar, radar, or also other suitable sensors 12 can be used as sensors 12. Sensors 12 can have an ellipsoidal radiating characteristic 13 with mutually overlapping sensor regions 14, so that full-coverage detection of driving track region 2 and/or of detection region 3 can be guaranteed; in other words, driving track region 2 and detection region 3 are located inside sensor regions 14 defined by sensors 12. Sensors 12 can be disposed at any desired positions on vehicle 1 and, for example, can monitor a sensor region 14 in front of, alongside, and/or behind vehicle 1. Sensors 12 thus detect objects 4, 5 in driving track region 2 and/or detection region 3, and convey data regarding the positions of objects 4, 5 in the coordinate system to a data processing unit of driver assistance system 10.

The data processing system can determine the motion of object 4, 5 on the basis of the position detected by the at least one sensor 12. For this, the sensor detects the position of object 4, 5 at at least two different points in time, so that the data processing unit can calculate the motion direction and speed of object 4, 5, in a known manner, e.g. vectorially. It is thus possible to identify whether object 4, 5 in detection region 3 and/or driving track region 2 is a stationary or a moving object 4, 5. The data processing unit can furthermore identify whether the stationary and/or moving object 4 in detection 3 is moving in the direction of driving track region 2, or whether the stationary and/or moving object 4 in detection region 3 will enter from detection region 3 into driving track 2 within a specific time span.

To signal a risk situation, driver assistance system 10 furthermore encompasses a signal transducer that is connected to the data processing unit and that receives data from the data processing unit regarding the position, motion direction, and speed of objects 4, 5. The signal transducer can deliver an optical and/or acoustic warning signal in the context of a risk situation. A risk situation can exist in particular when, for example, a moving object 4 is located in detection region 3, and/or the moving object 4 in detection region 3 is moving in the direction of the driving track, and/or the moving object 4 will enter from detection region 3 into driving track region 2 within a specific time span, and/or object 4 in detection region 3 is a stationary object 4 and stationary object 4 will enter from detection region 3 into driving track 2 within a specific time span. A risk situation can further be signaled when a stationary and/or moving object 5 is located in driving track region 2. The particular risk situation that is signaled by way of a warning signal can be adjusted variably.

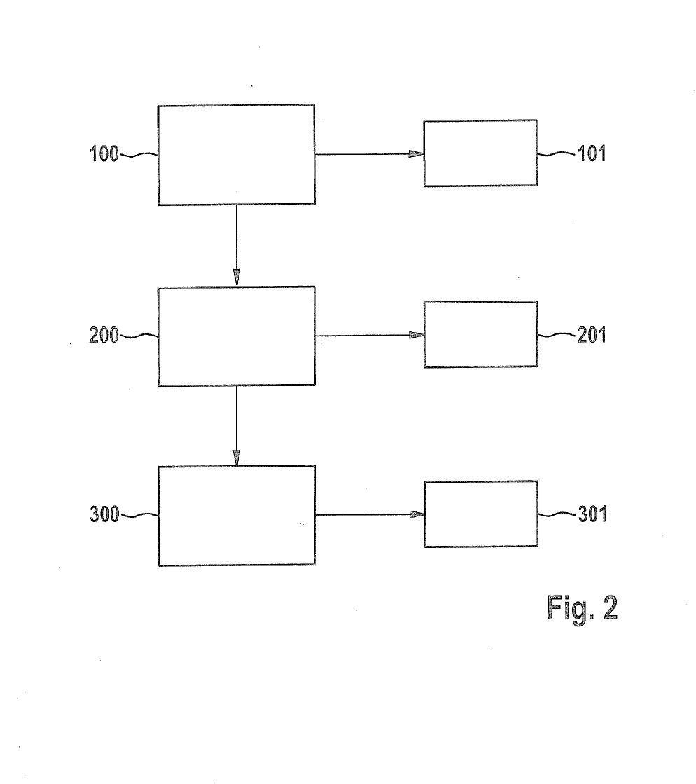

FIG. 2 is a flow chart for a method for warning of an object 4, 5 in the surroundings of a vehicle 1. The method encompasses the following steps:

Firstly, in a first method segment 100, a determination is made as to whether an object 5 is located in driving track region 2. If an object 5 is located in driving track region 2, this is correspondingly signaled (step 101) and carried out.

If a determination is made in first method step 100 that no object 5 is located in driving track region 2, a determination is then made in a subsequent method step 200 as to whether an object 4 is located in detection region 3, and whether the position of that object 4 has changed in such a way that an inference can be drawn therefrom that it is a moving object 4. If a moving object 4 is located in detection region 3, this is signaled in accordance with step 201.

If, however, it is determined in method step 200 that no moving object 4 is located in detection region 3, a determination is then made in a subsequent method step 300 as to whether a stationary object 4, which is moving into driving track region 2 as a result of an inherent motion of vehicle 1, is located in detection region 3. If this is ascertained, it is signaled by way of step 301.

The individual method steps 100, 200, 300 are not linked to any defined sequence; in other words, the individual method steps 100, 200, 300 can proceed in any sequence or even simultaneously.

In accordance with the method explained above, a risk is thus signaled, corresponding to steps 101, 201, 301, when an acute risk situation exists while vehicle 1 is being driven. The method does not carry out any evaluation of the absolute change in distance between vehicle 1 and object 4, 5; what instead takes place is a determination of the position, motion direction, and speed of object 4, 5 as a function of the vehicle motion. While vehicle 1 is being driven it is thus possible differentiate as to whether an object 4, 5 is a stationary object 4, 5, or whether object 4, 5 is a moving object 4, 5. Objects 4, 5 whose distance from vehicle 1 does not change, for example because they are moving parallel to vehicle 1, can likewise be recognized as collision-relevant.

In the method in accordance with FIG. 2, a signaling action in accordance with steps 101, 201, 301 is thus carried out when an object 5 is located in driving track region 2, and/or when a moving object 4 is located in detection region 3, and/or when a stationary object 4 is moving from detection region 3 into driving track region 2 as a result of an inherent motion of vehicle 1. Provision can also be made, however, that a collision warning is suppressed when a stationary object 4 that is not moving from detection region 3 into driving track region 2 as a result of an inherent motion of vehicle 1 is located in detection region 3. Such a situation does not represent an immediate risk situation, and is therefore not signaled. The driver of vehicle 1 is thus not distracted by superfluous signals.

Driving track region 2 and/or detection region 3 can be defined as a function of the vehicle speed. The result is that an elevated risk at higher speeds can be taken into account. For example, when the speed of vehicle 1 is 100 km/h, driving track region 2 can have a length 6 of 50 m and a width 7 of 3 m. For a corresponding speed, detection region 3 can, for example, entirely surround driving track region 2 with a width 9 of 2 m.

Signaling in accordance with steps 101, 201, 301 can occur in the form of an optical and/or acoustic and/or haptic signal.

1-10. (canceled)

11. A method for warning of an object in surroundings of a vehicle, the method comprising:
detecting a position of the object in a detection region in the surroundings of the vehicle, the detection region being a region in the surroundings of the vehicle and being adjacent to a driving track region of the vehicle, the driving track region being a region through which the vehicle will drive, within a predetermined time span;
determining a motion of the object based on multiple detected positions of the object; and
signaling when a determination is made that the object in the detection region is moving, wherein the signaling is performed only when a determination is made that the object in the detection region is moving into the driving track region within a specific time span.

12. The method of claim 11, wherein the signaling is performed only when a determination is made that the object in the detection region is moving in the direction of the driving track region.

13. The method of claim 11, wherein the signaling is performed when a determination is made that the object is stationary and will enter from the detection region into the driving track region within a specific time span.

14. The method of claim 11, further comprising:
detecting a position of a further object; and
signaling when a determination is made that the further object is located in the driving track region.

15. The method of claim 11, wherein at least one of a size and a shape of at least one of the driving track region and of the detection region is defined as a function of the vehicle speed.

16. The method of claim 11, wherein the signaling is performed at least one of optically and acoustically.

17. A computer readable medium having a computer program, which is executable by a processor, comprising:
a program code arrangement having program code for warning of an object in surroundings of a vehicle, by performing the following:
detecting a position of the object in a detection region in the surroundings of the vehicle, the detection region being a region in the surroundings of the vehicle and being adjacent to a driving track region of the vehicle, the driving track region being a region through which the vehicle will drive, within a predetermined time span;
determining a motion of the object based on multiple detected positions of the object; and
signaling when a determination is made that the object in the detection region is moving, wherein the signaling is performed only when a determination is made that the object in the detection region is moving into the driving track region within a specific time span.

18. A driver assistance system for warning of an object in surroundings of a vehicle, comprising:
at least one sensor for detecting a position of the object in a detection region in the surroundings of the vehicle, the detection region being a region in the surroundings of the vehicle and being adjacent to a driving track region of the vehicle, and the driving track region being a region that the vehicle will drive through, within a specific time span;
a data processing unit for determining a motion of the object based on multiple detected positions of the object; and
a signal transducer for signaling only when a determination is made that the object in the detection region is moving into the driving track region within a specific time span.

19. The driver assistance system of claim 18, wherein the at least one sensor is a sensor that monitors a sensor region at least one of in front of, alongside, and behind the vehicle.
